(19) United States
(12) Patent Application Publication
(10) Pub. No.: US 2004/0093444 A1
(43) Pub. Date: May 13, 2004

(54) PDA with business card dedicated build-in scanner

(76) Inventor: Ming-Zhen Liao, Yunlin (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/291,411

(22) Filed: Nov. 12, 2002

(51) Int. Cl. G06F 13/12

(52) U.S. Cl. 710/62

(57) ABSTRACT

It is a PDA with a business card dedicated build-in scanner. This invention is mainly building a card scanner inside the PDA, allowing the image-recording end to be accommodated on the specific space of the PDA surface. Relying on the structure above, user may scan the card by directly operating the button on the PDA. Then the image recorded may be automatically edited as a data file, which is convenient to view and look up. On the display of the PDA the data may show.

### BACKGROUND OF THE INVENTION

1. Field of the Invention

This invention is about a Personal Digital Assistant (PDA) with business card dedicated build-in scanner. It especially refers to a kind of PDA, which has a build-in business card scanner, and is able to scan business card into digital image that stored directly or after data processing, It is capable of providing the information user needed, and cutting down work flows and avoiding errors. It also makes users to take important business opportunities further.

2. Description of the Prior Art

Personal Digital Assistant (PDA) is a quite popular product in recent years. It differs from common portable electronic products with limited functions, as PDA can fulfill different work (e.g., writing, calculation etc.) by only loading of software, even the advanced PDA can add other functions (e.g., wireless telephone and digital camera etc.) by connecting to external devices or equipment. Therefore, in the irresistible tendency, the diffusion rate of PDA is rising up and up; the peripheral equipment ceaselessly puts forth new ideas.

However, like the statement above, to achieve different functions, PDA must be connected with external equipment, which is inconvenient, and even in a hindrance, deviating from the original purpose of easy operation. Especially for the businessman, connecting some cables while using PDA, will not only have inconvenience in work, but also have adverse impression effect on the costumers and other persons, even more make business opportunity losing.

As is well known, the society is transferring gradually into an era of service being the highest, and the contact among people is frequent. Going around on the street, you will get a lot of business cards, in which business opportunities are contained. Therefore, inputting business card into database will expand the business of the user, and as the data input of PDA is not convenient, connecting external business card scanner becomes a generalized module.

Please see FIG. 1, it is a traditional PDA 1, which externally connects to a business card scanner 2 by a transmission line 3 of special specification. The button 21 of business card scanner 2 can control image recording, and the image data will transfer into PDA 1 by transmission line 3, and get next process by the program of PDA 1, the digital data can be displayed on the screen 11 of PDA 1. But the operation of PDA 1 is inconvenient; the greatest failing is that with a big size, the scanner is inconvenient for carrying and easy for forgetting, which affects its normal functions. Also the business scanner 2 that must connect to PDA 1 is easy for breaking of connection, or being incapably of work. Even more, the power consumed by the business card scanner 2 is unmeasurable, during the scanning it may break for the running out of power.

In this way, the above traditional product has shortcomings and is not a perfect design. In view of the above shortcomings, in seeking for the solution, this inventor conceived the PDA with business card dedicated build-in scanner, which absolutely solved the above problem.

### SUMMARY OF THE INVENTION

The purpose of the convention is to provide a PDA with business card dedicated build-in scanner. The business card scanner is built in PDA, and is convenient to carry and operate. The user can conveniently input business card into PDA, cutting down manual flows like writing, sorting and classifying etc., avoiding errors and accurately taking important business opportunities further.

Another purpose of the invention is that the design will not damage the exterior of PDA, but provide the user with a nobly personal image and convenience whenever at ordinary times or in business.

In order to achieve the purpose described above, this invention builds a business card scanner in the PDA. However, the whole appearance of the PDA will not be impacted, and it is quiet easy to operate. Among which the image-recording end of the scanner is set on the specific space of PDA surface. A build-in transmission line links the scanner with the CPU of the PDA, therefore, the scanner could be controlled through operating the PDA. The recorded image may appear on a display directly or after processing. When the business card is available to the user, it only needs to take out the PDA conveniently and scan over the data surface of the card with the scanner, a specific pattern (all business cards of persons at home or aboard generally have similar pattern and content) of the general business card will appear. After the processing through using a software program which has special function, the image data of the card will be input into the DAP and then directly stored, alternatively, the data may be automatically edited as a data file convenient for viewing or looking up.

### BRIEF DESCRIPTION OF THE DRAWINGS

The drawings disclose an illustrative embodiment of the present invention, which serves to exemplify the various advantages and objects hereof, and are as follows:

FIG. 1. Schematic diagram of a traditional PDA connection to a scanner;

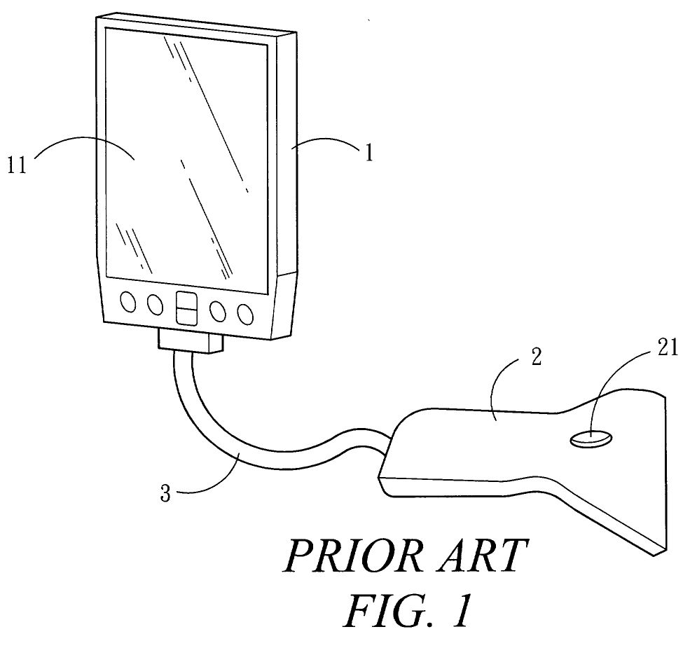

FIG. 2. Structural and organization diagram of the invention; and

FIG. 3. Operation illustration of the invention.

| | | | |
|---|---|---|---|
| 1 | Personal Digital | 11 | Display |
| | Assistant (PDA) | | |
| 2 | Business Card Scanner | 21 | Button |
| 3 | Transmission line | 4 | Personal Digital |
| | | | Assistant (PDA) |
| 41 | Business Card Scanner | 42 | Transmission Line |
| 43 | CPU | 44 | Button |
| 45 | Display | 5 | Business Card |
| 6 | Hand | | |

### DETAILED DESCRIPTION OF THE PREFERRED EMBODIMENT

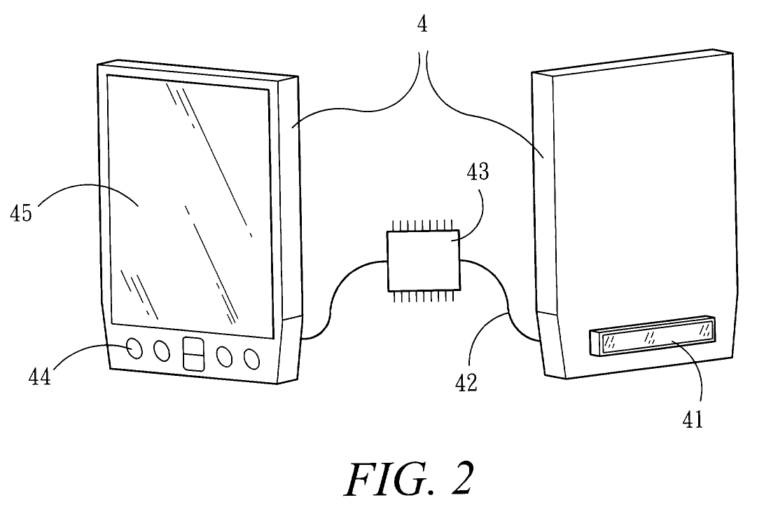

Please see FIG. 2, this invention is of providing a type a PDA 4 with business card dedicated build-in scanner. A card scanner 41 is built in the PDA 4, allowing the image-recording end of the scanner 41 to be accommodated in specific space on the surface of the PDA 4. A build-in transmission line 42 connects the scanner 41 to the CPU 43 of the PDA. Pressing the button 44 on the PDA 4, you may control the operation of the scanner 41 and the recorded image may be shown on the display 45 of the PDA 4.

Consideration of the space configuration for the scanner 41, in this example, the recording end is installed on the backside of the PDA 4. Of course it may be installed on the face or side of the PDA. The installation fully depends on the space and operability. The CPU 43 of the PDA 4 is the control unit, and the scanner 41 is controlled by the software program. And the data of the card recorded by the scanner could be automatically edited, and stored in a database, which is easy to view and check.

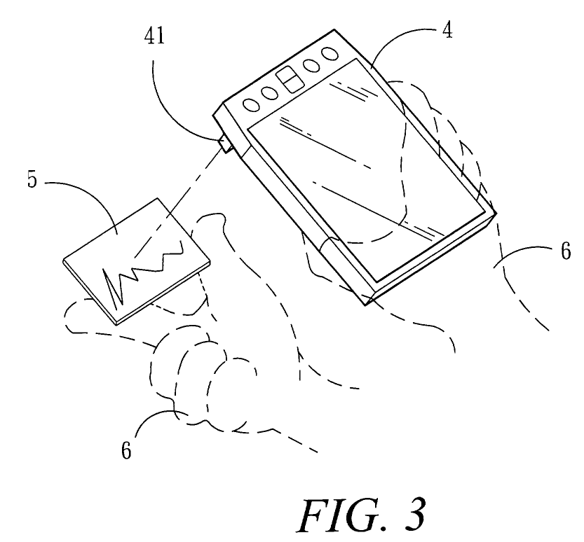

Please see FIG. 3, when the card 5 is available for the user, the PDA may be taken out conveniently. The way is holding card 5 with a hand and the other hand 6 appropriately holding PDA 4. Scanning the scanner over the surface of card 5 for reading the data as indicated in the figure, then the operation completed. This kind of operation mode is gentle in pose, quick and simple. User's personal impression will be impacted in the least, and the data missing will be avoided due to inputting data is made real time, so as to the business opportunity would be grasped.

Through comparing the PDA in which the business card dedicated scanner built with the other traditional technology, the content and data on the specific pattern (all business cards of persons at home or aboard generally have similar pattern and content) of the general business cards may be processed using the program that in procession of special functions; in addition, it is portal and easy to operate because the scanner is built in the PDA, as this result, real-time inputting is feasible and the man induced missing and forgetting may be avoided. Accordingly, that is as aid to grasp the latest data and expand the commercial opportunity. Meanwhile, the design of the invention will not damage the outline of the PDA, and provide the operation with character of simply and naturally. The operation of the device could be carried out whenever and wherever so that it is more convenient.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A PDA, which has a business card dedicated build-in scanner, the improvement comprising:
A PDA has a build-in business card scanner, whose image-recording end is contained on the specific space of the PDA surface And a build-in transmission line connects the scanner to the CPU of the PDA by pressing the button on the PDA, you may control the scanner operation Alternatively, a recorded image will show on the display of the PDA.

2. A PDA with build-in dedicated card scanner of claim 1, the operation orders for scanner are controlled by software program, the CPU processing those orders.

3. A PDA with build-in dedicated card scanner of claim 1, among which the PDA may automatically edit the card data that recorded by the scanner into a database, which is convenient to view and look up.
